(19) United States
(12) Patent Application Publication
(10) Pub. No.: US 2026/0001021 A1
(43) Pub. Date: Jan. 1, 2026

(54) HOUSING FOR A PLEATED FILTER AND METHOD FOR MANUFACTURING THEREOF

(71) Applicants: SMITS EMMEN VASTGOED B.V., OLDENZAAL (NL); Pishar, Inc., NORTH MIAMI, FL (US)

(72) Inventor: Sebastiaan STENEKES, EMMEN (NL)

(73) Assignees: SMITS EMMEN VASTGOED B.V., OLDENZAAL (NL); Pishar, Inc., NORTH MIAMI, FL (US)

(21) Appl. No.: 19/112,122

(22) PCT Filed: Jun. 22, 2023
(86) PCT No.: PCT/EP2023/067000

§ 371 Date: Mar. 14, 2025

(30) Foreign Application Priority Data
Sep. 16, 2022 (WO) PCT/EP2022/075870

(51) Int. Cl. B01D 46/00; B01D 46/52

(52) U.S. Cl. CPC B01D 46/0005; B01D 46/521; B01D 2265/028

(57) ABSTRACT

The invention relates to a housing for a pleated filter, comprising a front wall having at least one inflow opening, a back wall arranged at a distance therebehind and having at least one outflow opening, and a top wall and a bottom wall which each extend between the front and back walls, wherein each of the front, back, top and bottom walls is integrally made. The top wall and the bottom wall may be mechanically fixed to each of the front and back walls, e.g. by clicking or clamping. The invention also relates to a method for manufacturing such a housing for a pleated filter.

The invention relates to a housing for a pleated filter. In particular the invention relates to such a housing which comprises a front wall having at least one inflow opening, a back wall arranged at a distance there behind and having at least one outflow opening, and a top wall and a bottom wall which each extend between the front and back walls. Such a housing is known from WO 2012/164084 A1.

Pleated filters are used for a variety of purposes. In particular, pleated filters are used for filtering air which is supplied to a space or to a machine. For instance, air which is drawn into the inlet of a stationary turbine for power generation is usually led through one or more filters. The same applies to air that is used for ventilating so-called “clean rooms”, where operations are performed for which the air must be absolutely free of dust and contamination. And at large scale poultry farms air is increasingly being filtered to prevent poultry from being infected by airborne viruses.

Pleated filters provide good flow characteristics, since they have a relatively large throughflow area. On the other hand, pleated filters take up relatively little space due to their zigzag folded arrangement.

The filter housing of WO 2012/164084 A1 is made up of a bottom cell part and a top cell part. At the front, these top and bottom cell parts are connected by two side support elements and three inner support elements, which together define four inlet apertures. At the back, the top and bottom cell parts are connected by four outer support elements. The various support elements are positioned in respective recesses in the top and bottom cell parts.

The prior art filter housing is complex and its assembly is both time-consuming and costly. Moreover, it is hard to guarantee absolute air tightness, due to the multitude of connections between the various parts. Consequently there is a risk of air leaking past the filter and contaminating the machine or space to which the air is supplied.

The invention now has for its object to provide a housing for a pleated filter in which these drawbacks are obviated at least to some extent. In accordance with the invention, this is accomplished in a housing of the type described above in that each of the front, back, top and bottom walls is integrally made. By making each wall as an integral part, rather than from a plurality of separate parts, there is no longer any need for complex and time consuming assembly operations, while the risk of leakage is reduced by elimination of the various connections.

In an embodiment of the housing, the top wall is mechanically fixed to at least one of the front and back walls. In this way a stable connection between the various walls is obtained.

Additionally or alternatively, the bottom wall may be mechanically fixed to at least one of the front and back walls as well, again in order to obtain a stable connection between the walls.

In a further embodiment of the housing, such fixation may be achieved when the top wall and/or the bottom wall is clicked or clamped to the front wall and/or the back wall. Clicking or clamping are techniques which allow for a fixed connection to be established swiftly and securely.

In an embodiment of the housing, the top wall may have at least one connecting edge including a plurality of fixation elements. This allows the top wall to be connected to the front wall or the back wall over the entire length of one of its edges. The fixation elements may include protrusion, like clips, lugs, cams or ribs, which may cooperate with apertures, slots, grooves or other types of recesses in the wall to which the top wall is to be fixed. Alternatively, the fixation elements may include recesses for cooperation with protrusions on the front or back wall.

In a further embodiment, the connecting edge of the top wall may have a profile that is at least partially complementary to a profile of a corresponding edge of the front wall or the back wall. These complementary profiles result in a form-fitting connection, which adds stability to the housing.

Additionally or alternatively, the bottom wall may also have at least one connecting edge including a plurality of fixation elements. These fixation elements may be of the same general types discussed above in connection with the top wall. Here again, the connecting edge of the bottom wall may have a profile that is at least partially complementary to a profile of a corresponding edge of the front wall or the back wall.

In an embodiment of the housing, the top wall and the bottom wall may be identical. This leads to a reduction in the number of individual parts that are used for manufacturing the housing, with an associated reduction in the number of separate molds that are needed.

In another embodiment, the front wall may include a plurality of inflow openings bounded by substantially vertical bars, a substantially horizontal top bar and a substantially horizontal bottom bar, all said bars being integrally formed. Integrally forming the bars which bound the inflow openings avoids the formation of joints which may give rise to air leaks.

In a further embodiment of the housing, the top and bottom bars may each include an edge member extending towards the back wall, and fixation elements at or near said edge members. This allows the front wall to be stably fixed to the top and bottom walls, while the edge member may also serve to cover an edge of the filter material in the housing to prevent air leaking past.

Air leaks may further be prevented when a leftmost vertical bar and a rightmost vertical bar each include an edge member extending towards the back wall.

As an additional measure against leakage of air the walls may be sealingly connected to each other.

In an embodiment, the housing may be provided with means for fixing the pleated filter, so that no leakage will occur between the filter and the housing parts.

The filter fixing means may comprise grooves for accommodating edges of the pleated filter.

In a further embodiment of the housing, the walls may be made of a plastic material. Plastic materials allow relatively complex shapes to be integrally formed. Moreover, plastic materials have favourable structural and physical properties and are easy to process.

The walls may be made by injection moulding. This technique allows integral parts to be formed at relatively low cost.

The invention further relates to a method for manufacturing a housing for a pleated filter.

As discussed above, prior art document WO 2012/164084 A1 discloses a method which includes providing a bottom wall, arranging two side support elements and three inner support elements on the bottom wall to form a front wall having four inflow openings, arranging four outer support elements on the bottom wall to form a back wall having three outflow openings, and placing a top wall on the side support elements, the inner support elements and the outer support elements to close the housing.

The method of the present invention, on the other hand, includes the steps of forming a front wall having at least one inflow opening, forming a back wall having at least one outflow opening, forming a top wall and forming a bottom wall, and then connecting the walls to each other, wherein each of the front, back, top and bottom walls is formed in one piece.

In an embodiment of this method, the top wall may be mechanically fixed to at least one of the front and back walls.

In another embodiment of the method, the bottom wall may be mechanically fixed to at least one of the front and back walls.

In yet another embodiment, the walls may be sealingly connected to each other.

The walls may be made of a plastic material.

The walls may be made by injection moulding.

The invention is now illustrated by way of an exemplary embodiment thereof, with reference being made to the annexed drawings, in which:

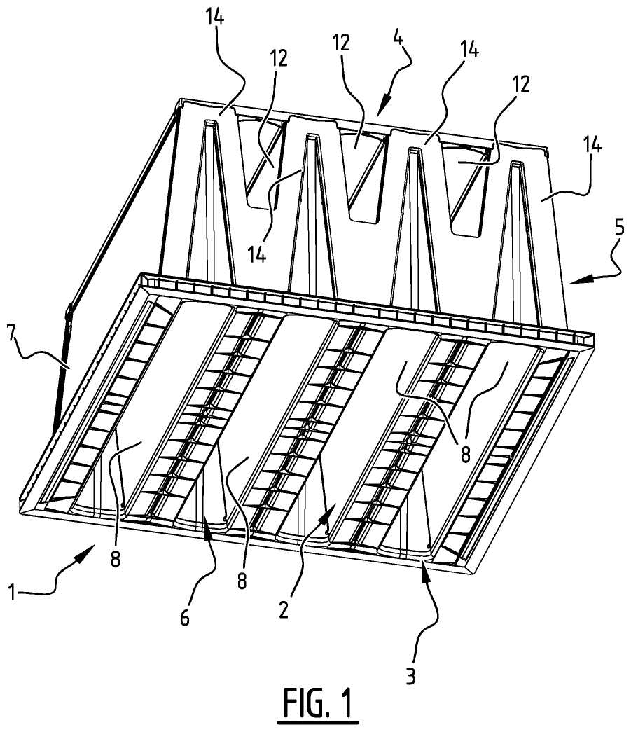

FIG. 1 is a perspective view from an inflow side of a filter including a housing in accordance with an embodiment of the invention;

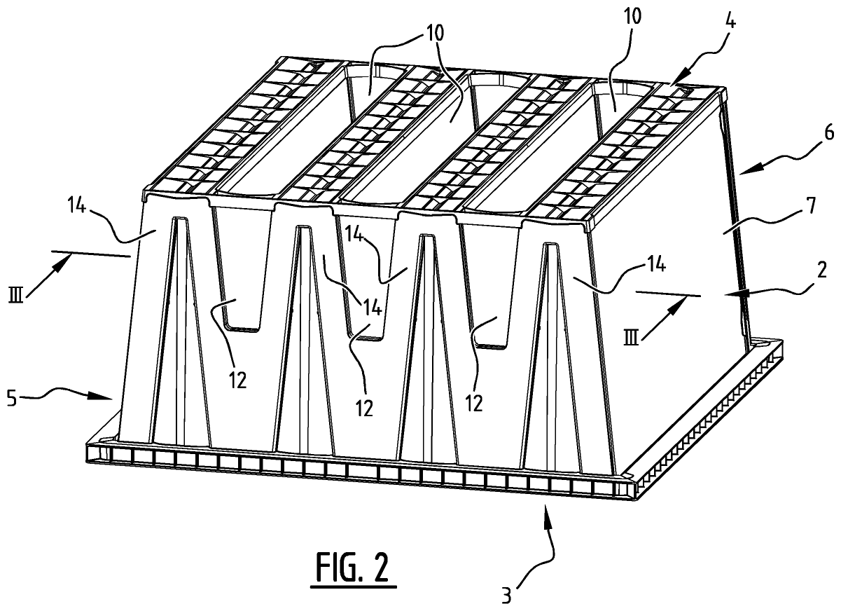

FIG. 2 is a perspective view of the filter of FIG. 1 as seen from an outflow side;

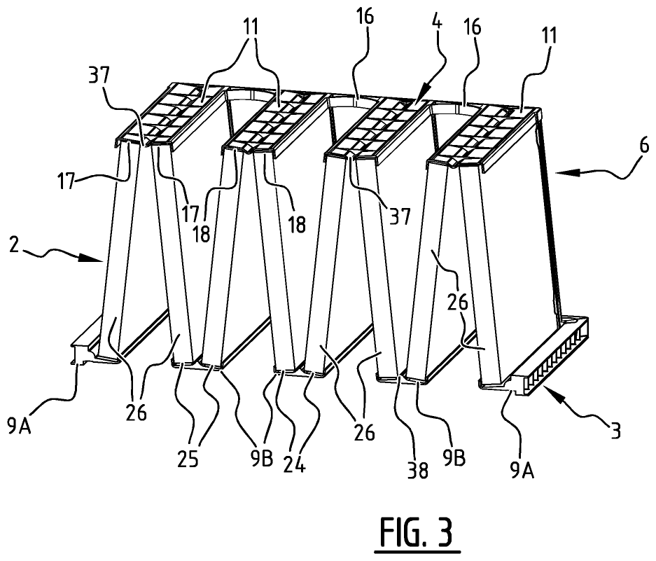

FIG. 3 is a cross-sectional perspective view along the line III-III in FIG. 2;

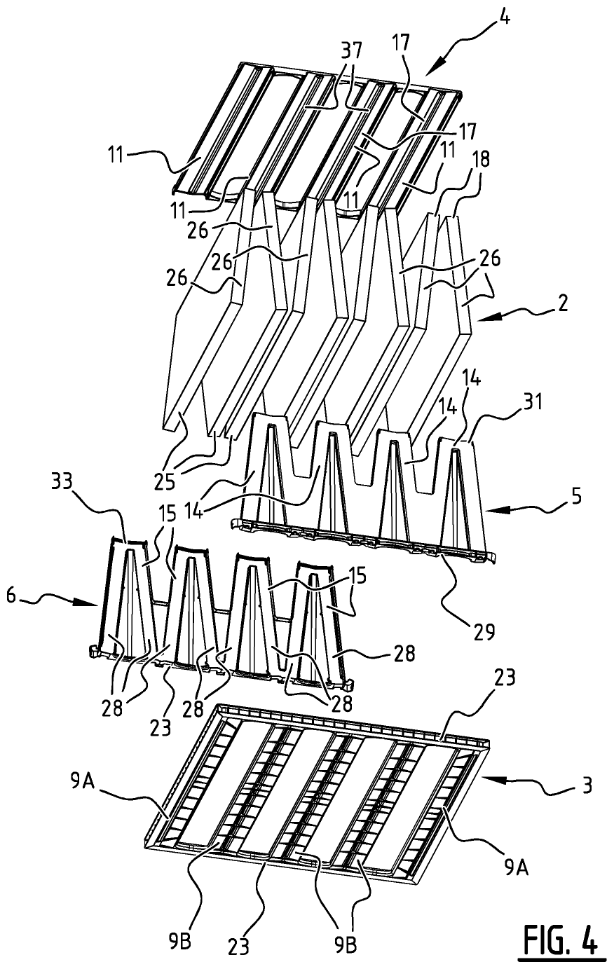

FIG. 4 is an exploded perspective view of the parts forming the filter of FIGS. 1 and 2 as seen from the inflow side;

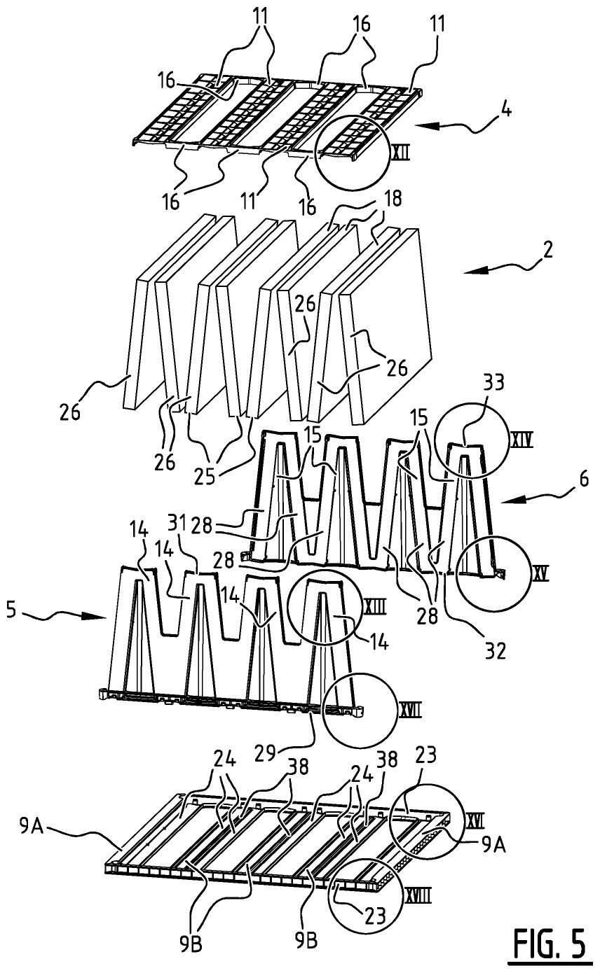

FIG. 5 is an exploded perspective view of the parts forming the filter of FIGS. 1 and 2 as seen from the outflow side;

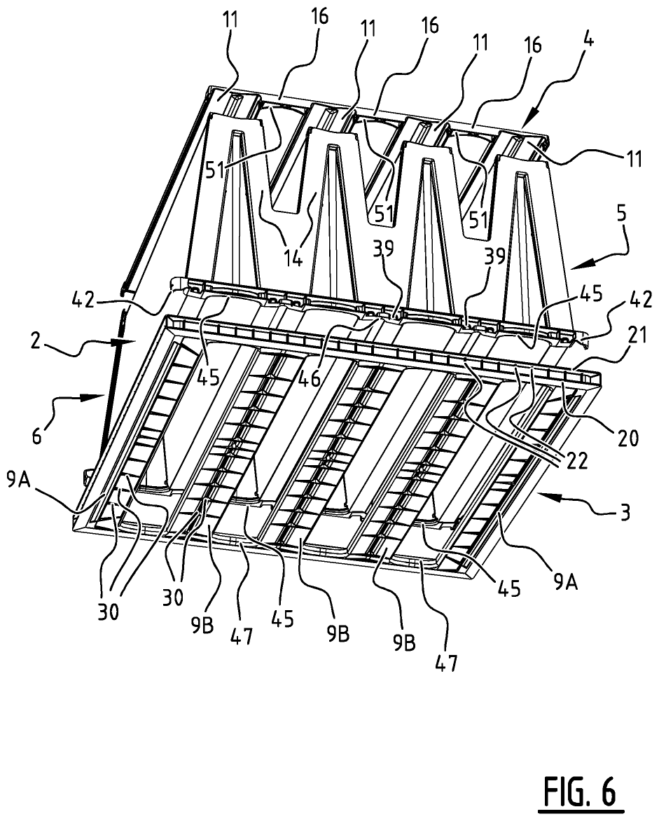

FIG. 6 is an exploded perspective view from the inflow side of the filter of FIGS. 1 and 2;

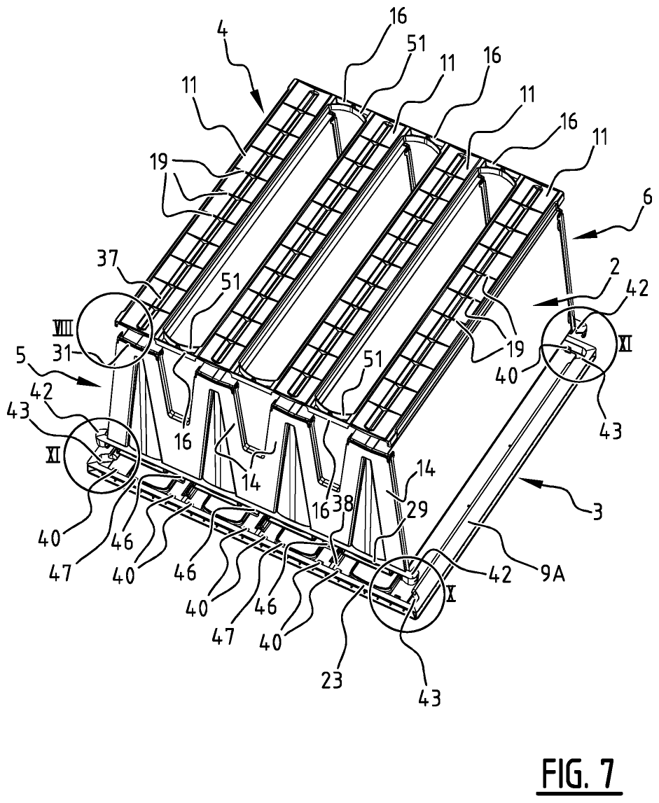

FIG. 7 is an exploded perspective view from the outflow side of the filter of FIGS. 1 and 2;

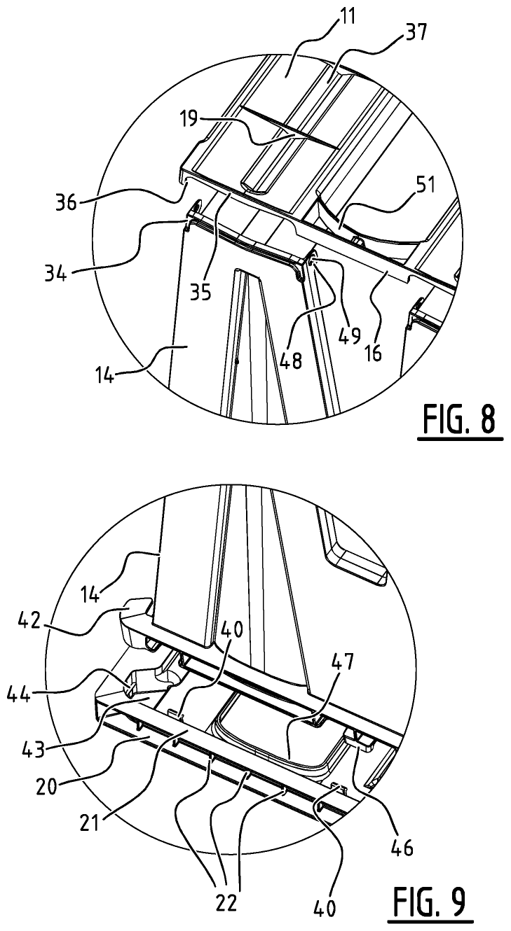

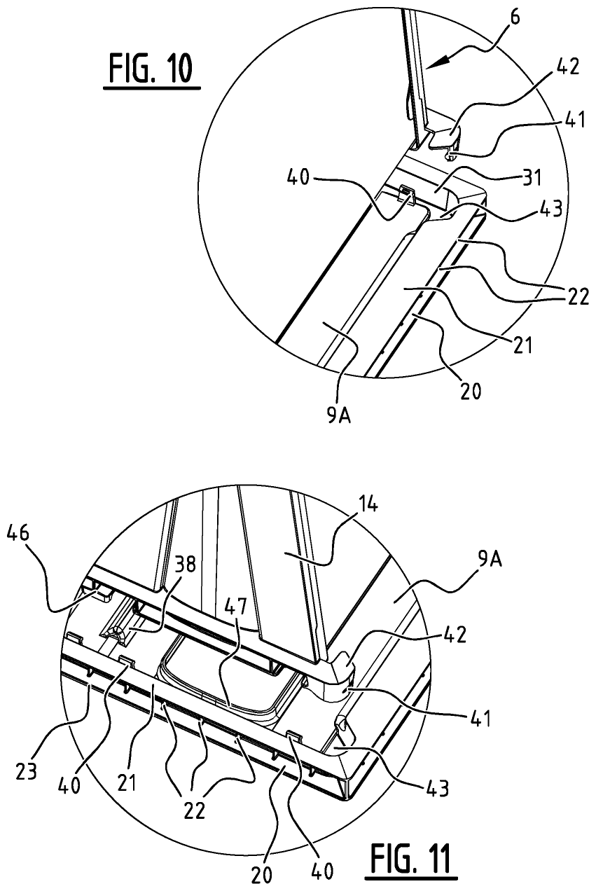

FIGS. 8-11 are enlarged scale views of the details VIII-XI, respectively, in FIG. 7; and

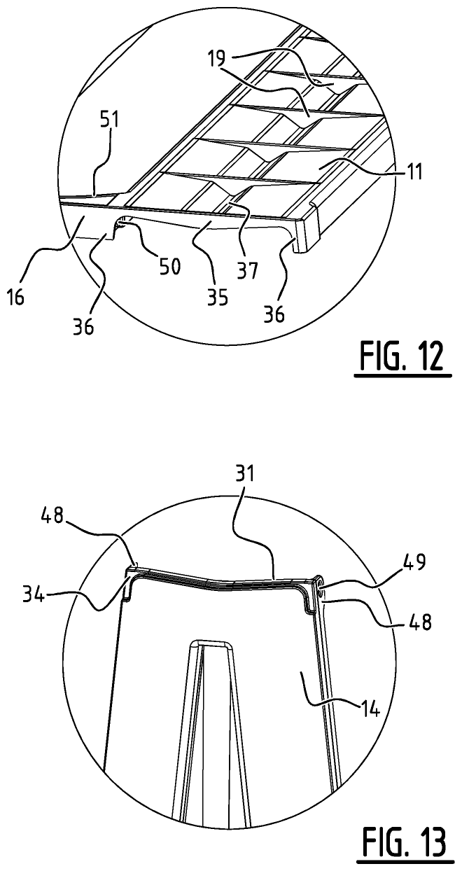

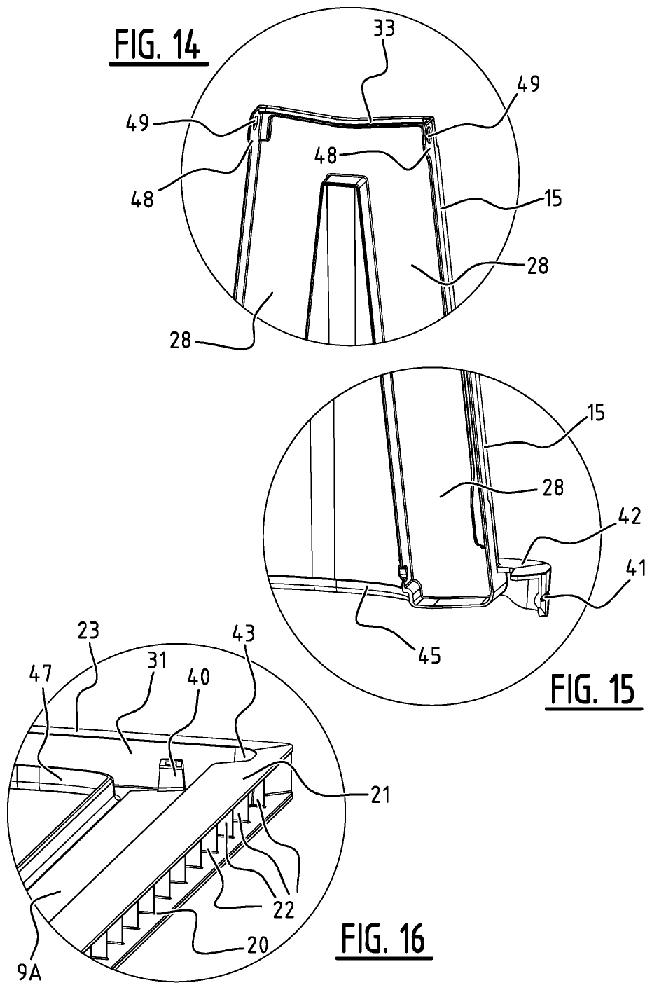

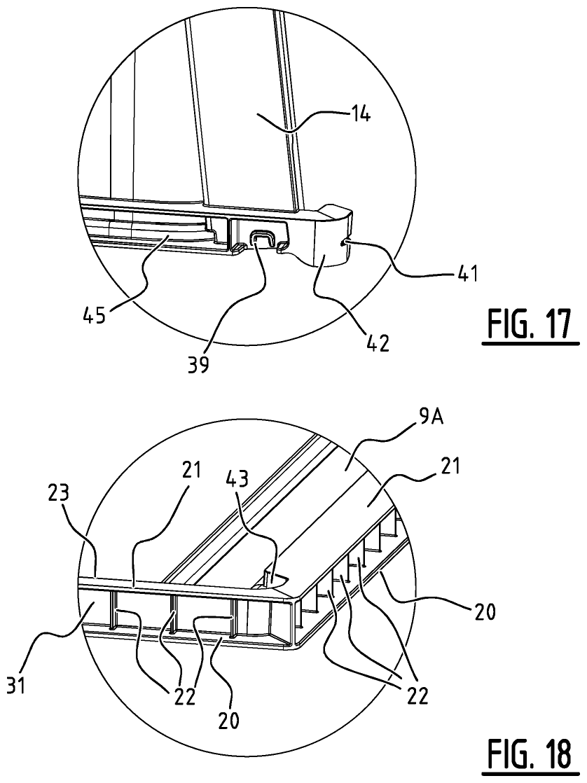

FIGS. 12-18 are enlarged scale views of the details XII-XVIII, respectively, in FIG. 5.

A housing 1 for a pleated filter 2 includes a front wall 3, a back wall 4, a top wall 5 and a bottom wall 6 (FIG. 1). The various walls 3-6 of the housing 1 define an interior space I, in which the pleated filter 2 is accommodated.

In the illustrated embodiment the front wall 3 has four inflow openings 8 extending over substantially the entire height of the front wall 3 and bounded by five vertical bars 9. Due to the pleated configuration of the filter 2, the back wall 4 has only three outflow openings 10, which also extend over approximately the full height of this wall 4 (FIG. 2). These outflow openings 10 are bounded by four vertical bars 11. The top wall 5 and the bottom wall 6 also include three outflow openings 12, 13 each. These outflow openings 12, 13 are bounded by four fingers 14, 15, which extend substantially at right angles to the front and back walls 3, 4. In order to conform to the pleated filter 2, the fingers 14, 15 taper from the front wall 3 towards the back wall 4. And finally, the open sides 7 between the front and back walls 3, 4 also serve as outflow openings.

In accordance with the invention, the various walls 3-6 of the housing 1 are each integrally made. In particular, the front wall 3 is made in one piece, the back wall 4 is made in one piece, the top wall 5 is made in one piece and the bottom wall 6 is made in one piece (FIGS. 4, 5). Each of these walls 3-6 may be made of a plastic material and may be formed by injection moulding.

The one-piece back wall 4 consists of the four bars 11 and three pairs of bridging pieces 16 connecting these bars 11 at their opposite ends. Each of the bars 11 has a cross section which includes a divider 37 to define two parallel grooves 17. Each groove 17 is adapted for accommodating a standing back edge 18 of a segment 26 of the pleated filter 2 (FIG. 3). Stiffeners 19 are arranged at regular intervals on the outsides of the bars 11 and interconnect the two grooves 17. The bridges 16 connecting the bars 11 are double-walled and include a curved inner wall 51 for increased strength and stiffness.

The one-piece front wall 3 includes not only the five vertical bars 9, but also upper and lower horizontal bars 23 which connect the vertical bars 9. The leftmost and rightmost vertical bars 9A and the top and bottom horizontal bars 23 form a frame which provides the required structural integrity for the front wall 3. To this end these bars 9A, 23 each have a double-walled structure made up of a first layer 20 and a second layer 21, which are spaced apart and held together by a plurality of intermediate ribs 22 and inner webs 52. These inner webs 31 define edges which extend towards the back wall 4.

Like the bars 11 of the back wall 4, the three central bars 9B of the front wall 3 also have a cross section that includes a divider 38, so as to define two grooves or channels 24 (FIG. 3) for accommodating forward facing standing edges 25 of the pleated filter 2. On the outside of the bars 9 the channels are bridged by stiffeners 30. The two end bars 9A, i.e. the leftmost bar and the rightmost bar, have only a single groove or recess, since they serve to accommodate the forward edge of only a single segment 26 of the pleated filter 2. The grooved or double-grooved cross section further has inwardly inclined or rounded edges of the inflow openings 8, which is favourable from an aerodynamic point of view.

Each of the rearwardly extending fingers 14, 15 of the one-piece top wall 5 and the one-piece bottom wall 6, respectively, also includes two grooves or channels 27, 28 for accommodating the upper and lower edges 53, 54, respectively, of the pleated filter 2. The grooves or channels 27, 28 of each individual finger 14, 15 of the top and bottom walls 5, 6 converge towards the free end of that finger, i.e. towards a back connecting edge 31, 33 of the respective wall 5, 6. The grooves or channels 27, 28 of adjacent fingers 14, 15 meet near a front connecting edge 29, 32 of the respective wall 5, 6. As a result, the grooves or channels 27, 28 define a zigzag configuration for the pleated filter 2. The grooves or channels 27, 28 are further provided with means for fixing the filter 2 (not shown).

The housing 1 is assembled by mechanically connecting the top wall 5 and the bottom wall 6 to both the front wall 3 and the back wall 4. In particular, the top and bottom walls 5, 6 are fixedly connected to the front and back walls 3, 4, so that the housing 1 is stable and form retaining, even before the pleated filter 2 is introduced into the housing 1. The top and bottom walls 5, 6 may be mechanically fixed to the front and back walls 3, 4 by or clamping.

In the illustrated embodiment, the top wall 5 has a front connecting edge 29 for fixing the top wall 5 to the front wall 3 and a back connecting edge 31 for fixing the top wall 5 to the back wall 4. In similar fashion, the bottom wall 6 has front and back connecting edges 32, 33 for fixing the bottom wall 6 to the front wall 3 and to the back wall 4, respectively.

In the illustrated embodiment the front connecting edge 29 of the top wall 5 has a profile that is at least partially complementary to a profile of the corresponding edge of the top horizontal bar 23 of the front wall 3. Similarly, the back connecting edge 31 of the top wall 5 has a profile that is at least partially complementary to a profile of the corresponding top edge of the back wall 4. Also the front connecting edge 32 of the bottom wall 6 has a profile that is at least partially complementary to a profile of the corresponding edge of the bottom horizontal bar 23 of the front wall 3. And the back connecting edge 33 of the bottom wall 6 has a profile that is at least partially complementary to a profile of the corresponding bottom edge of the back wall 4. These complimentary profiles result in form-fitting connections between the various walls 3-6.

In the illustrated embodiment the fixation elements on the front connecting edge 29 of the top wall 5 comprise a plurality of U-shaped ridges 39 which are intended to cooperate with hooks or clips 40 that are arranged at a spacing from the inner edge of the top horizontal bar 23. The fixation elements further comprise grooves 41 formed in protruding end parts 42 of the front connecting edge 29, which serve to cooperate with ridges 44 formed in recesses 43 in the top horizontal bar 23.

The front connecting edge 32 of the bottom wall 6 has similar fixation elements as the top wall 5, and the inner edge of the bottom horizontal bar 23 of the front wall 3 has similar hooks, clips and ridges as the top horizontal bar 23. In this embodiment, the top and bottom walls 5, 6 are identical, and the front wall 3 is symmetrical about a horizontal center line.

The profile of the front connecting edge 29 of the top wall 5 includes the protruding end parts 42, as well as curved wall parts 45 at the end of each finger 14, and supports 46 between each pair of U-shaped ridges 39. The protruding end parts 42 fit in the recesses 43 of the top horizontal bar 23, while the curved wall parts 45 fittingly receive curved edge parts 47 of the inflow openings 8 in the front wall 3. The supports 46 are fittingly received between the inner edge 31 of the top horizontal bar 23 and ends of the dividers 38 of the central vertical bars 9A of the front wall 3. In this way the top wall 5 is locked to the front wall 3.

Since the top and bottom walls 5, 6 are identical, and the front wall 3 is symmetrical, the profile of the front connecting edge 32 of the bottom wall 6 and the profile of the inner edge of the bottom horizontal bar 23 are identical to those of the top wall 5 and top horizontal bar 23, respectively.

In the illustrated embodiment the fixation elements on the back connecting edge of the top wall 5 comprise a pair of lugs 48 having apertures 49 at the end of each finger 14. These apertures are intended to receive inwardly protruding pins 50 arranged at the top end of each double-grooved bar 11 of the back wall 4. In similar fashion, the fixation elements on the back connecting edge of the bottom wall 6 comprise pairs of apertured lugs 48 at the ends of fingers 15 for receiving pins 50 at the bottom end of the bars 11.

Moreover, the profile of the back connecting edge of the top wall 5 includes a full width recess 34 at the end of each of the fingers 14, which serves to accommodate a tongue 35 and corner pieces 36 at the top of each bar 11. The thickness of the end of each finger 14 matches a distance between the tongue 35 and the divider 37 of the double-grooved bar 11, thus further locking the top wall 5 to the back wall 4. Similar arrangements are made at the ends of the fingers 15 of the bottom wall 6.

Once the various walls 3-6 have been fixedly connected by the fixation elements and the complementary profiles, all connections are sealed by applying a sealant, so as to prevent any leakage.

In actual practice, two or three of the walls will first be assembled and mechanically connected before the pleated filter 2 is introduced. Then the remaining wall(s) will be mechanically connected to finish assembly of the housing 1. The front and back edges 18, 25 and the top and bottom edges 53, 54 of the filter segments 26 are sealed to the corresponding grooves or channels 17, 24, 27, 28 of the housing 1 by introducing a liquid sealant or adhesive, e.g. a polyurethane adhesive between these parts and letting it cure or set.

After assembly of the housing 1 including the pleated filter 2 has been completed, the filter is ready for use. It will normally be built into an opening in an inflow duct for supplying filtered air either to a space or to a machine. The parts of the front wall 3 extending horizontally and vertically beyond the top and bottom wall 5,6 serve as a frame for maintaining the housing 1 in the opening. Air to be filtered will flow into the housing through the inflow openings 8 and will then flow through the segments 26 of the pleated filter 2. After passing through the filter 2 part of the air flow will leave the housing 1 through the outflow openings 10 in the back wall 4, while another part of the air flow will leave the housing 1 through the sides 7. Finally, part of the air flow will be discharged through the outflow openings 12, 13 in the top and bottom walls 5, 6.

In this way the invention provides an easy to manufacture filter housing having improved air tightness.

Further features of the invention are defined in the following clauses:

Clause 1. A housing for a pleated filter, the housing comprising:
a front wall comprising at least one inflow opening;
   a back wall arranged at a distance therebehind and comprising at least one outflow opening; and
a top wall and a bottom wall which each extend between the front and back walls, wherein each of the front, back, top, and bottom walls is integrally made.

Clause 2. The housing of clause 1, wherein the top wall is mechanically fixed to at least one of the front and back walls; the bottom wall is mechanically fixed to at least one of the front and back walls; or both the top and bottom walls are mechanically fixed to at least one of the front and back walls.

Clause 3. The housing of clause 2, wherein the top wall is clicked or clamped to the front wall, the back wall, or both.

Clause 4. The housing of clause 2, wherein the bottom wall is clicked or clamped to the front wall, the back wall, or both.

Clause 5. The housing of clause 2, wherein the top wall comprises at least one connecting edge comprising a plurality of fixation elements.

Clause 6. The housing of clause 5, wherein the at least one connecting edge of the top wall comprises a profile that is at least partially complementary to a profile of a corresponding edge of the front wall or the back wall.

Clause 7. The housing of clauses 2, wherein the bottom wall comprises at least one connecting edge comprising a plurality of fixation elements.

Clause 8. The housing of clause 7, wherein the at least one connecting edge of the bottom wall comprises a profile that is at least partially complementary to a profile of a corresponding edge of the front wall or the back wall.

Clause 9. The housing of clause 1, wherein the top wall and the bottom wall are identical.

Clause 10. The housing of clause 1, wherein the front wall comprises a plurality of inflow openings bounded by substantially vertical bars, a substantially horizontal top bar, and a substantially horizontal bottom bar, all of said bars being integrally formed.

Clause 11. The housing of clause 10, wherein the top and bottom bars each comprise an edge member extending towards the back wall, said edge members comprising fixation elements.

Clause 12. The housing of clause 10, wherein a leftmost vertical bar and a rightmost vertical bar each comprise an edge member extending towards the back wall.

Clause 13. The housing of clause 1, wherein the walls are sealingly connected to each other.

Clause 14. The housing of clause 1, further comprising means for fixing the pleated filter.

Clause 15. The housing of clause 14, wherein the filter fixing means comprises grooves for accommodating edges of the pleated filter.

Clause 16. An assembly comprising:
a pleated filter; and
a housing for the pleated filter, the housing comprising:
   a front wall comprising at least one inflow opening;
   a back wall arranged at a distance therebehind and comprising at least one outflow opening; and
   a top wall and a bottom wall which each extend between the front and back walls;
wherein the pleated filter is installed within the housing.

Clause 17. A method for manufacturing a housing for a pleated filter, wherein the method comprises the steps of:
(a) forming a front wall comprising at least one inflow opening;
(b) forming a back wall comprising at least one outflow opening;
(c) forming a top wall and forming a bottom wall; and
(d) connecting the walls to each other, wherein each of the front, back, top, and bottom walls is formed in one piece.

Clause 18. The method of clause 18, wherein the top wall is mechanically fixed to at least one of the front and back walls.

Clause 19. The method of clause 18, wherein the bottom wall is mechanically fixed to at least one of the front and back walls.

Clause 20. The method of clause 18, wherein the walls are sealingly connected to each other

Although an exemplary embodiment of the invention has been shown and described, it will be apparent that many modifications and variations may be made without departing from the scope of the invention. For instance, the shape and dimensions of the walls, the number of inflow and outflow openings etc. could be varied. The same holds true for the way in which the filter material is arranged and fixed in the housing. It is further conceivable that face guards could be arranged at the sides of the housing 1.

The scope of the invention is therefore solely defined by the appended claims.

1.-23. (canceled)

24. A housing for a pleated filter, the housing comprising:
a front wall comprising at least one inflow opening;
a back wall arranged at a distance behind the front wall and comprising at least one outflow opening; and
a top wall and a bottom wall which each extend between the front and back walls,
wherein each of the front, back, top, and bottom walls is integrally made.

25. The housing of claim 24, wherein one of:
the top wall is mechanically fixed to at least one of the front and back walls;
the bottom wall is mechanically fixed to at least one of the front and back walls; or
both the top and bottom walls are mechanically fixed to at least one of the front and back walls.

26. The housing of claim 25, wherein the top wall is clicked or clamped to the front wall, the back wall, or both.

27. The housing of claim 25, wherein the bottom wall is clicked or clamped to the front wall, the back wall, or both.

28. The housing of claim 25, wherein the top wall comprises at least one connecting edge comprising a plurality of fixation elements.

29. The housing of claim 28, wherein the at least one connecting edge of the top wall comprises a profile that is at least partially complementary to a profile of a corresponding edge of the front wall or the back wall.

30. The housing of claim 25, wherein the bottom wall comprises at least one connecting edge comprising a plurality of fixation elements.

31. The housing of claim 30, wherein the at least one connecting edge of the bottom wall comprises a profile that is at least partially complementary to a profile of a corresponding edge of the front wall or the back wall.

32. The housing of claim 24, wherein the top wall and the bottom wall are identical.

33. The housing of claim 24, wherein the front wall comprises a plurality of inflow openings bounded by substantially vertical bars, a substantially horizontal top bar, and a substantially horizontal bottom bar, wherein all said bars are integrally formed.

34. The housing of claim 33, wherein the top and bottom bars each comprise an edge member extending towards the back wall, said edge members comprising fixation elements.

35. The housing of claim 33, wherein a leftmost vertical bar and a rightmost vertical bar each comprise an edge member extending towards the back wall.

36. The housing of claim 24, wherein the walls are sealingly connected to each other.

37. The housing of claim 24, further comprising filter fixing means for fixing the pleated filter.

38. The housing of claim 37, wherein the filter fixing means comprises grooves for accommodating edges of the pleated filter.

39. An assembly comprising:
a pleated filter; and
a housing for the pleated filter, the housing comprising:
a front wall comprising at least one inflow opening;
a back wall arranged at a distance behind the front wall and comprising at least one outflow opening; and
a top wall and a bottom wall which each extend between the front and back walls;
wherein the pleated filter is installed within the housing.

40. A method for manufacturing a housing for a pleated filter, wherein the method comprises the steps of:
(a) forming a front wall comprising at least one inflow opening;
(b) forming a back wall comprising at least one outflow opening;
(c) forming a top wall and forming a bottom wall; and
(d) connecting the walls to each other, wherein each of the front, back, top, and bottom walls is formed in one piece.

41. The method of claim 40, wherein the top wall is mechanically fixed to at least one of the front and back walls.

42. The method of claim 40, wherein the bottom wall is mechanically fixed to at least one of the front and back walls.

43. The method of claim 40, wherein the walls are sealingly connected to each other.
